(19) United States
(12) Patent Application Publication
(10) Pub. No.: US 2011/0170042 A1
(43) Pub. Date: Jul. 14, 2011

(54) Reflective color filters and display devices including the same

(75) Inventors: Eun-hyoung Cho, Seoul (KR); Oleg Prudnikov, Yongin-si (KR); Jin-seung Sohn, Seoul (KR); Hae-sung Kim, Hwaseong-si (KR)

(73) Assignee: Samsung Electronics Co., Ltd.

(21) Appl. No.: 12/923,274

(22) Filed: Sep. 13, 2010

(30) Foreign Application Priority Data
Jan. 14, 2010 (KR) 10-2010-0003548

(51) Int. Cl. G02F 1/1335

(52) U.S. Cl. 349/106

(57) ABSTRACT

A reflective color filter may include a substrate, a photonic crystal layer including a plurality of photonic crystal patterns, and a light energy conversion device. The substrate may be between the light energy conversion device and the photonic crystal patterns. A reflective display device may include a liquid crystal layer having a light transmittance that is electrically controlled, a thin film transistor (TFT)-array layer including a plurality of TFTs for driving the liquid crystal layer according to image information, and a reflective color filter adapted to reflect light having a wavelength band corresponding to a photonic band gap from among light incident through the liquid crystal layer.

### CROSS-REFERENCE TO RELATED APPLICATION(S)

This application claims priority from Korean Patent Application No. 10-2010-0003548, filed on Jan. 14, 2010, in the Korean Intellectual Property Office (KIPO), the entire contents of which are incorporated herein by reference.

### BACKGROUND

1. Field

Example embodiments relate to reflective color filters that may include a light energy conversion device. Example embodiments also relate to display devices that may include the reflective color filter. In example embodiments, charging may be possible during operation of the display devices.

2. Description of the Related Art

Mobile display devices, such as mobile phones, portable multimedia players (PMPs), and/or ultra-mobile personal computers (UMPCs) may be used not only in indoor areas but also in outdoor areas, especially, in outdoor areas under very bright conditions. Accordingly, a mobile display device, such as a mobile phone, a PMP, or a UMPC, should have high visibility irrespective of the ambient light conditions. Also, since in a bright environment, ambient light may be reflected by a surface of a display unit to a user's eyes, a contrast ratio may be lowered. The light reflected by the surface of the display unit may be mixed with light emitted from a panel as well, thereby degrading the color purity of the display unit.

In order to reduce power consumption of the panel when the mobile display device is used for a long time, the mobile display device may be a reflective display device that may use ambient light as a light source in a bright environment.

Photonic crystal color filters based on structural colors may have recently been studied for use as color filters in reflective display devices. Photonic crystal color filters may include nanostructures smaller than the wavelengths of light in order to control the reflection and/or absorption of light incident from the outside so that light of a desired color may be reflected (or transmitted) and/or light of other colors may be transmitted (or reflected).

Such photonic crystal color filters may include nano-sized unit blocks that may be periodically arranged at regular intervals. Optical characteristics of the photonic crystal color filters may be determined by the size and/or period of the nanostructures. Accordingly, the photonic crystal color filters having excellent wavelength selectivity and/or a color bandwidth that may be easily adjusted may be manufactured by forming nanostructures suitable for a predetermined wavelength.

### SUMMARY

Example embodiments may provide reflective color filters that may include light energy conversion devices.

Example embodiments may provide reflective display devices that may include the reflective color filters, so that charging may be possible during use of the reflective display device.

Additional aspects will be set forth in part in the description which follows and, in part, may be apparent from the description, and/or may be learned by practice of example embodiments.

According to example embodiments, a reflective color filter may include a substrate (that may or may not be transparent), a photonic crystal layer that may include a plurality of photonic crystal patterns formed on the substrate, and/or a light energy conversion device that may face the plurality of photonic crystal patterns with the substrate therebetween.

The reflective color filter may further include a barrier layer disposed between the substrate and the photonic crystal layer.

The plurality of photonic crystal patterns may have a relatively high refractive index, and/or the photonic crystal layer may include a low refractive index layer covering the plurality of photonic crystal patterns and/or may have a relatively low refractive index.

Each of the plurality of photonic crystal patterns may have an island shape, and/or the plurality of photonic crystal patterns may be grouped into photonic crystal units of different sizes respectively corresponding to red light, green light, and/or blue light.

The photonic crystal units may be arranged in a stripe shape, a mosaic shape, a delta shape, or some other shape.

The reflective color filter may further include light cut-off layers disposed on the plurality of photonic crystal patterns. The light cut-off layers may be formed, for example, of silicon oxide and/or silicon nitride.

The light energy conversion device may be a solar cell.

According to example embodiments, a reflective display device may include a liquid crystal layer having a transmittance that may be electrically controlled, a thin film transistor (TFT)-array layer that may include a plurality of TFTs for driving the liquid crystal layer according to image information, and/or the reflective color filter of claim 1 for reflecting light having a wavelength band corresponding to a photonic band gap from among light incident through the liquid crystal layer.

The reflective display device may further include an incident light unit disposed over the liquid crystal layer. The incident light unit may be a light-emitting diode (LED).

Accordingly, light having a specific wavelength band may be reflected and/or may be used for display. Light having other wavelength bands may be transmitted and/or the transmitted light may be converted into energy by the light energy conversion device. The energy may be used as driving power of the display device and, thus, the display device may be used for a long time. Furthermore, since a separate incident light generating unit may be provided, visibility of the display device may be improved irrespective of ambient light.

According to example embodiments, a reflective color filter may include a substrate, a photonic crystal layer including a plurality of photonic crystal patterns, and/or a light energy conversion device. The substrate may be between the light energy conversion device and the photonic crystal patterns.

According to example embodiments, a reflective display device may include a liquid crystal layer having a light transmittance that is electrically controlled, a thin film transistor (TFT)-array layer including a plurality of TFTs for driving the liquid crystal layer according to image information, and/or a reflective color filter adapted to reflect light having a wavelength band corresponding to a photonic band gap from among light incident through the liquid crystal layer.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a perspective view of an optical filter according to example embodiments;

FIG. 2 is a cross-sectional view of the color filter of FIG. 1;

FIG. 3 is a graph illustrating reflectance and transmittance spectra at a reflective surface and a transmissive surface of a photonic crystal color filter;

FIGS. 4 and 5 are graphs illustrating time responses at the reflective surface and the transmissive surface when light having a transmission wavelength band and light having a reflection wavelength band are incident on the photonic crystal color filter;

FIG. 6 is a cross-sectional view of a reflective color filter according to example embodiments;

FIGS. 7A through 7C are plan views illustrating arrangements of a plurality of photonic, crystal units of the reflective color filter of FIG. 6, according to example embodiments; and

FIG. 8 is a cross-sectional view of a display device according to example embodiments.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions are exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

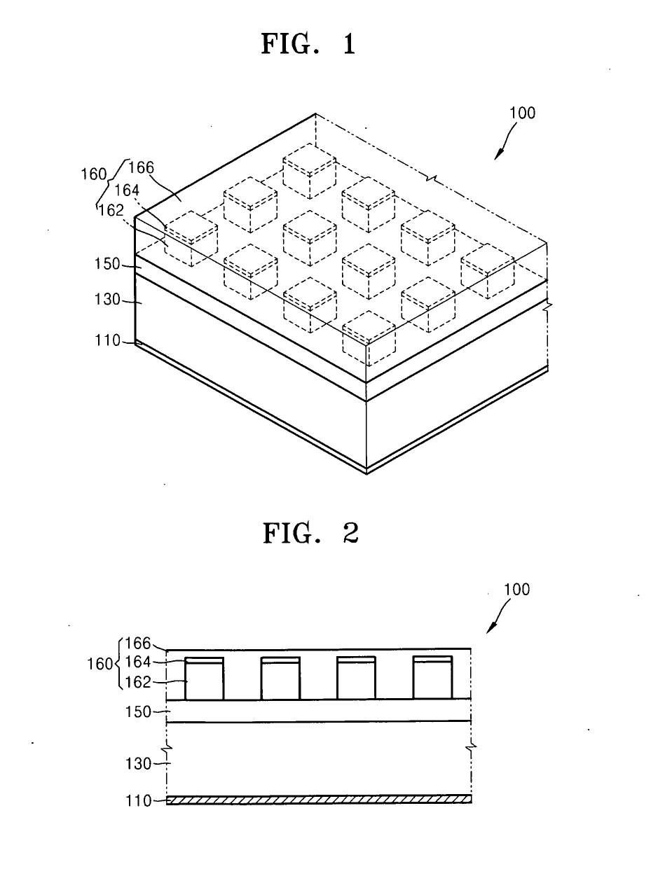

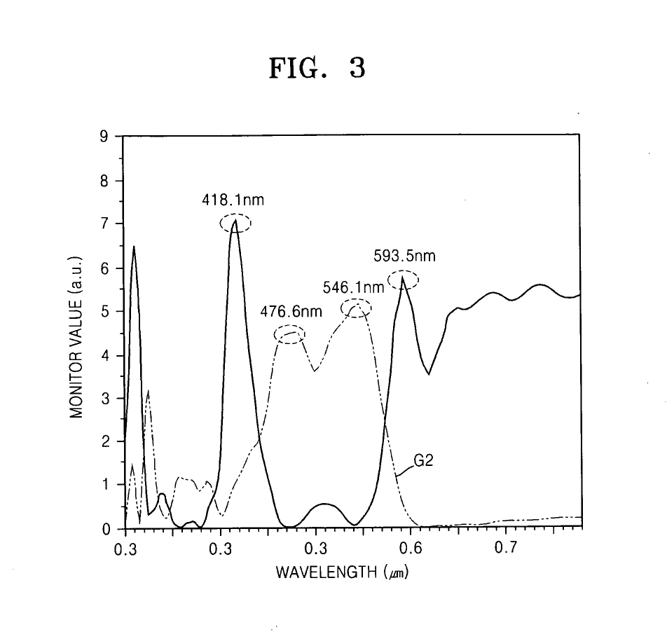

FIG. 1 is a perspective view of color filter 100 according to example embodiments. FIG. 2 is a cross-sectional view of color filter 100 of FIG. 1.

Referring to FIGS. 1 and 2, color filter 100 may include transparent substrate 130, barrier layer 150 formed on substrate 130, photonic crystal layer 160 formed on barrier layer 150, and/or solar cell 110 disposed under substrate 130. Solar cell 110 may be a light energy conversion device. If white light is incident on photonic crystal layer 160, light having a first wavelength band may be reflected by photonic crystal layer 160, and/or light having wavelength bands other than the first wavelength band may be transmitted through photonic crystal layer 160. A resonance wavelength is between the first wavelength band and the wavelength bands. The light transmitted through photonic crystal layer 160 may be used as a light energy source of solar cell 110.

Photonic crystal layer 160 may reflect light having a wavelength band corresponding to a photonic band gap according to a periodic distribution of refractive indices. Photonic crystal layer 160 may include photonic crystal patterns 162 having a relatively high refractive index; periodically arranged, low refractive index layer 166 having a relatively low refractive index; and/or light cut-off layers 164 formed on photonic crystal patterns 162. Each of photonic crystal patterns 162 may have an island shape. The plurality of photonic crystal patterns 162 of photonic crystal layer 160 may be arranged in a shape (that may or may not be predetermined), for example, in a lattice shape.

Although photonic crystal patterns 162 may have a rectangular parallelepiped shape in FIG. 1, example embodiments are not limited thereto. Photonic crystal patterns 162 may have a circular cylindrical shape, a polygonal pillar shape, or one or more other shapes.

Photonic crystal patterns 162 may have a refractive index greater than that of low refractive index layer 166. For example, a difference between real parts of refractive indices of photonic crystal patterns 162 and low refractive index layer 166 may be 2 or more (e.g., |n₁₆₂|−|n₁₆₆|≧2). Imaginary parts of the refractive indices of photonic crystal patterns 162 and low refractive index layer 166 may be 0.1 or less in a visible light wavelength band. As an imaginary part of a refractive index increases, a reflectance may decrease. Accordingly, each of photonic crystal patterns 162 and low refractive index layer 166 may be formed of a material having a refractive index, an imaginary part of which is small. Photonic crystal patterns 162 may be formed of one or more of single-crystalline silicon, polycrystalline silicon (poly Si), AlSb, AlAs, AlGaAs, AlGaInP, BP, and ZnGeP₂. Low reflective index layer 166 may be formed of one or more of Air, polycarbonate (PC), polystyrene (PS), poly(methyl methacrylate) (PMMA), Si₃N₄, and SiO₂. Low refractive index layer 166 may be a support layer for supporting an array of photonic crystal patterns 162. Low refractive index layer 166 may cover top surfaces of photonic crystal patterns 162 and/or spaces between photonic crystal patterns 162. In other words, low refractive index layer 166 may cover the array of photonic crystal patterns 162.

A structure having low refractive index layer 166 may be determined to prevent damage to photonic crystal patterns 162 when photonic crystal patterns 162 formed of, for example, amorphous silicon are crystallized into single-crystalline silicon or poly Si.

Light cut-off layers 164 may improve cut-off characteristics of color filter 100. Light cut-off layers 164 may be formed of silicon oxide, for example, SiO₂, or silicon nitride, for example, Si₃N₄. Substrate 130 may act as a waveguide. Due to a crystalline structure of photonic crystal layer 160, from among incident light incident on photonic crystal layer 160, light having a specific wavelength band may be reflected by photonic crystal layer 160 and/or light having wavelengths other than the specific wavelength band may be transmitted through photonic crystal layer 160 and/or trapped in substrate 130. Substrate 130 may be, for example, a glass substrate. Barrier layer 150 may be disposed between substrate 130 and photonic crystal layer 160.

During a crystallization process, impurities in substrate 130 may migrate into photonic crystal patterns 162 of photonic crystal layer 160. In this case, crystalline purity of photonic crystal patterns 162 may be degraded. For example, if photonic crystal patterns 162 are formed of material including silicon, crystalline purity of the silicon may be degraded. However, barrier layer 150 may prevent the crystalline purity of photonic crystal patterns 162 from being degraded during the crystallization process.

Barrier layer 150 may be a material layer having a refractive index similar to that of substrate 130. Barrier layer 150 may be formed of the same material as that of low refractive index layer 166.

Solar cell 110 may have the same structure as a general n-type or p-type silicon thin film solar cell. If color filter 100 is applied to a reflective display device, part of incident light incident on color filter 100 may be reflected by color filter 100 and/or may be used for color generation of the reflective display device. Most of the remaining part of the incident light may be transmitted through substrate 130, barrier layer 150, and/or photonic crystal layer 160. The light transmitted through substrate 130, barrier layer 150, and/or photonic crystal layer 160 may be used as an energy source of solar cell 110. Solar cell 110 may additionally produce a driving current by using the light transmitted through substrate 130, barrier layer 150, and/or photonic crystal layer 160.

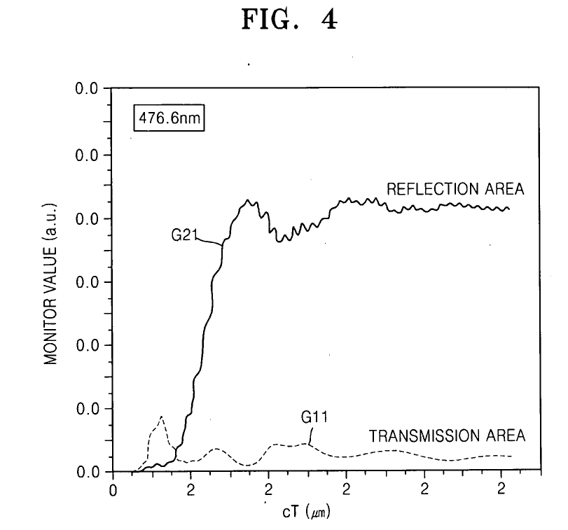

FIG. 3 is a graph illustrating reflectance and transmittance spectra at a reflective surface and a transmissive surface of a photonic crystal color filter. A first graph G1 of FIG. 3 illustrates reflectance and transmittance spectra at the transmissive surface, and a second graph G2 of FIG. 3 illustrates reflectance and transmittance spectra at the reflective surface.

Referring to FIG. 3, if light including all frequency components is incident on the photonic crystal color filter, light having a green wavelength band is reflected by the photonic crystal color filter and light having wavelength bands other than the green wavelength band is transmitted through the photonic crystal color filter.

Accordingly, the light having the green wavelength band which is reflected by the photonic crystal color filter may be used for green color generation, and the light, that is, light having a central peak at wavelength of 418.1 nm and light having wavelength bands of 600 nm or more, other than the light having the green wavelength may be used for charging a solar cell. The same mechanism applies to blue and red photonic crystal color filters.

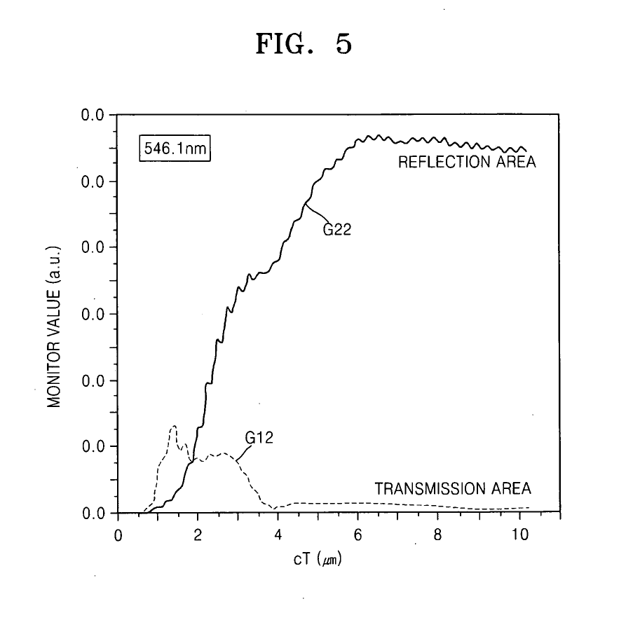

FIGS. 4 and 5 are graphs illustrating time responses at the reflective surface and the transmissive surface when light having a transmission wavelength band and light having a reflection wavelength band are incident on the photonic crystal color filter. First graphs G11 and G12 of FIGS. 4 and 5 illustrate time responses at the transmissive surface, and second graphs G21 and G22 of FIGS. 4 and 5 illustrate time responses at the reflective surface.

Referring to FIGS. 4 and 5, if light having transmission wavelength bands, i.e., 418.1 nm and 593.5 nm, is incident on the photonic crystal color filter, a time response at a transmission area is greater than a time response at a reflection area. Accordingly, most of the light incident on the photonic crystal color filter is transmitted.

On the contrary, if light having reflection wavelength bands, i.e., around 476.6 nm and around 546.1 nm, is incident on the photonic crystal color filter, a time response at the reflection area is greater than a time response at the transmission area. Accordingly, most of the light incident on the photonic crystal color filter is reflected.

Color filter 100 constructed as described above may reflect light having a specific wavelength band due to photonic crystal layer 160 forming a periodic distribution of refractive indices. The specific wavelength band and/or a band range of the specific wavelength band may be determined by the shape of an array of photonic crystal patterns 162 and/or the period of photonic crystal patterns 162. The shape of the array and/or the period of photonic crystal patterns 162 may be determined and/or color filter 100 having a good filtering performance may be used in various fields. For example, color filter 100 may be applied to a solar cell, a quantum dot-light emitting diode (QD-LED), and an organic light-emitting diode (OLED). Color filter 100 also may be used as a color filter of a display device, as will be described below.

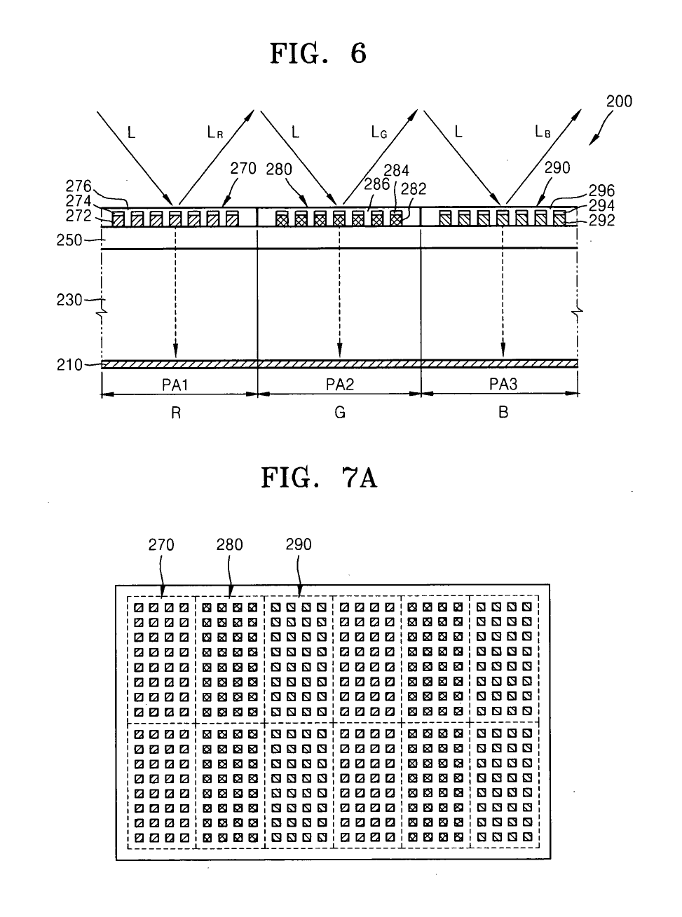

FIG. 6 is a reflective color filter 200 according to example embodiments.

Referring to FIG. 6, reflective color filter 200 may include transparent substrate 230, barrier layer 250 formed on substrate 230, a plurality of photonic crystal units 270, 280, and 290, formed on barrier layer 250 and/or adapted to reflect light having wavelength bands (that may or may not be predetermined), and/or solar cell 210 formed under substrate 230. Solar cell 210 may be a light energy conversion device. Solar cell 210 may be attached to a bottom surface of substrate 230. A top surface of barrier layer 250 may be divided into a plurality of pixel areas (e.g., first pixel area PA1, second pixel area PA2, and/or third pixel area PA3). Red photonic crystal unit 270 may reflect red light L_{R} from among incident light L and/or may be disposed in first pixel area PA1. Green photonic crystal unit 280 may reflect green light L_{G} from among incident light L and/or may be disposed in second pixel area PA2. Blue photonic crystal unit 290 may reflect blue light L_{B} from among incident light L and/or may be disposed in third pixel area PA3. However, red photonic crystal unit 270, green photonic crystal unit 280, and/or blue photonic crystal unit 290 may be disposed differently. For example, blue photonic crystal unit 290 may be disposed in first pixel area PA1 and/or red photonic crystal unit 270 may be disposed in third pixel area PA3.

Red photonic crystal unit 270 may include photonic crystal patterns 272 having a relatively high refractive index and/or low refractive index layer 276 having a relatively low refractive index. Photonic crystal patterns 272 and/or low refractive index layer 276 may be periodically arranged. Green photonic crystal unit 280 may include photonic crystal patterns 282 having a relatively high refractive index and/or low refractive index layer 286 having a relatively low refractive index. Photonic crystal patterns 282 and/or low refractive index layer 286 may be periodically arranged. Blue photonic crystal unit 290 may include photonic crystal patterns 292 having a relatively high refractive index and/or low refractive index layer 296 having a relatively low refractive index. Photonic crystal patterns 292 and/or low refractive index layer 296 may be periodically arranged.

Light cut-off layers 274, 284, and/or 294 may be respectively formed on photonic crystal patterns 272, 282, and/or 292. Photonic crystal patterns 272, 282, and 292 may have island shapes. Photonic crystal patterns 272, 282, and/or 292, low refractive index layers 276, 286, and/or 296, and light cut-off layers 274, 284, and/or 294 may be formed of materials respectively used to form photonic crystal patterns 162, low refractive index layer 166, and/or light cut-off layers 164 of FIG. 1. Photonic crystal patterns 272, 282, and/or 292 may be formed of the same material or different materials. Low refractive index layers 276, 286, and/or 296 may be formed of the same material or different materials. Light cut-off layers 274, 284, and/or 294 may be formed of the same material or different materials. Shapes formed by photonic crystal patterns 272, 282, and/or 292 and/or periods of photonic crystal patterns 272, 282, and/or 292 may be different from one another in order to have photonic band gaps corresponding to red, green, and/or blue colors.

Solar cell 210 may absorb light that may be transmitted through substrate 230 and/or may be incident to solar cell 210. The absorbed light may not be reflected for color generation. That is, light not reflected by red photonic crystal unit 270, green photonic crystal unit 280, and/or blue photonic crystal unit 290 may pass through substrate 230 and/or may reach solar cell 210 to be converted into energy.

As described the above, reflective color filter 200 of FIG. 6 may reflect light having a specific wavelength band from among incident light and/or may use the reflected light for display purpose. Also, reflective color filter 200 may convert light having wavelength bands other than the specific wavelength band into energy using solar cell 210 (that may be a light energy conversion device). Accordingly, the light having the wavelength bands other than the specific wavelength band may be used as driving power of a display device, thereby making it possible to drive the display device for a longer time.

Although only three photonic crystal units 270, 280, and 290 forming a basic pixel may be illustrated in FIG. 6, reflective color filter 200 may have a structure in which plurality of photonic crystal units 270, 280, and/or 290 may be repeatedly arranged.

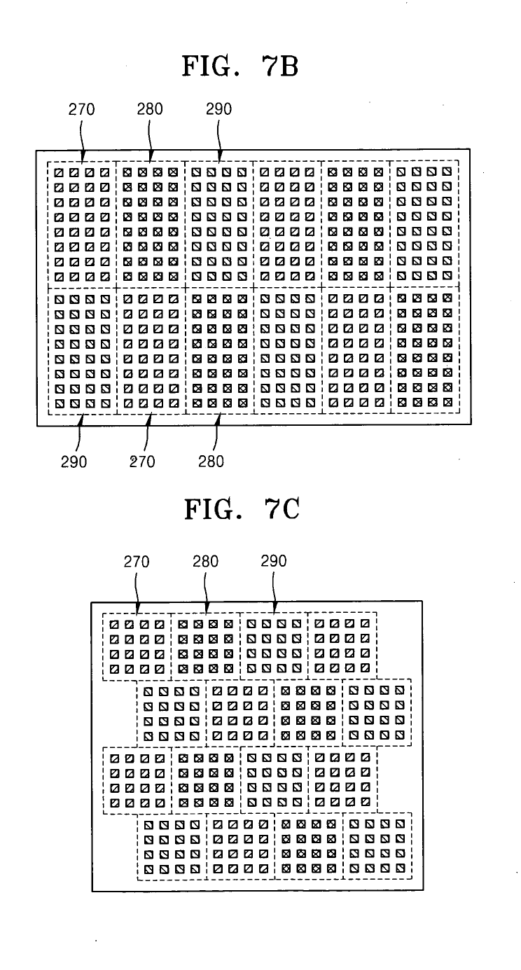

FIGS. 7A through 7C are plan views illustrating arrangements of plurality of photonic crystal units 270, 280, and 290 of reflective color filter 200 of FIG. 6, according to example embodiments.

Referring to FIG. 7A, a plurality of red photonic crystal units 270 may be arranged in a stripe shape. That is, red photonic crystal units 270 may be aligned on a line in a given direction. Each of a plurality of green photonic crystal units 280 and/or a plurality of blue photonic crystal units 290 may be arranged in a stripe shape. Each of green photonic crystal units 280 and/or blue photonic crystal units 290 may be arranged in the same direction as plurality of red photonic crystal units 270, or in one or more different directions.

Referring to FIG. 7B, each of plurality of red photonic crystal units 270, plurality of green photonic crystal units 280, and/or plurality of blue photonic crystal units 290 may be arranged in a mosaic shape. In this case, one of red photonic crystal units 270, green photonic crystal units 280, and/or blue photonic crystal units 290 may be surrounded by the remaining two photonic crystal units.

Referring to FIG. 7C, red photonic crystal units 270, green photonic crystal units 280, and blue photonic crystal units 290 may be arranged in such a manner that lines connecting centers of red photonic crystal units 270, green photonic crystal units 280, and blue photonic crystal units 290 may form a delta (A) shape.

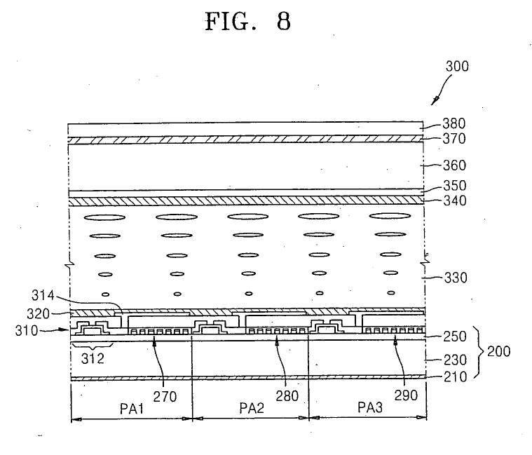

FIG. 8 is a cross-sectional view of display device 300 according to example embodiments.

Referring to FIG. 8, display device 300 may include liquid crystal layer 330 (a light transmittance of which may be electrically controlled), reflective color filter 200 (including solar cell 210 for reflecting light having a wavelength band corresponding to a photonic band gap from among light incident through liquid crystal layer 330), and/or a thin film transistors (TFT)-array layer 310 that may include a plurality of TFTs 312 for driving liquid crystal layer 330 according to image information. Reflective color filter 200 may have substantially the same structure as reflective color filter 200 of FIG. 3. Accordingly, a detailed explanation of reflective color filter 200 will not be given.

TFT-array layer 310 may include plurality of TFTs 312 and/or plurality of pixel electrodes 314. At least one of TFTs 312 and one of red photonic crystal units 270, green photonic crystal units 280, and blue photonic crystal units 290 may be disposed in each of first pixel area PA1, second pixel area PA2, and third pixel area PA3. TFTs of each of pixel areas PA1, PA2, and/or PA3 may be located adjacent to each of photonic crystal units 270, 280, and/or 290. TFTs 312 and/or photonic crystal units 270, 280, and/or 290 may be formed on the same substrate.

A transmittance of liquid crystal layer 330 for light incident thereon may be electrically controlled. Liquid crystal layer 330 may be disposed between two transparent substrates 230 and 360. Orientation layers 340 and 320 may be disposed over and under liquid crystal layer 330. Liquid crystal layer 330 may be formed of any of various types of liquid crystals. For example, liquid crystal layer 330 may be formed of twisted nematic (TN) liquid crystals, mixed-mode TN (MTN) liquid crystals, polymer dispersed liquid crystals (PDLC), Heilmeier-Zanoni (HZ) liquid crystals, and/or Cole-Kashnow (CK) liquid crystals.

Electrode 350 (that may or may not be transparent) may be disposed on a first surface of substrate 360 facing liquid crystal layer 330. That is, electrode 350 may be disposed between substrate 360 and liquid crystal layer 330. Polarization plate 370 may be disposed on a second surface of substrate 360 opposite to the first surface of substrate 360, for example, on a top surface of substrate 360. Polarization plate 370 may be omitted depending on the type and/or driving mode of liquid crystal layer 330. Alternatively, a quarter-wave plate, or a polarization plate having a polarization axis that may be perpendicular to a polarization axis of polarization plate 370 may be further provided.

If display device 300 is a reflective display device, display device 300 may use ambient light. Accordingly, in a dark environment, brightness of display device 300 may be reduced. Accordingly, incident light unit 380 may be additionally disposed over liquid crystal layer 330 to act as a light source. Incident light unit 380 may include an array of LEDs. Visibility of display device 300 may be improved even in a dark environment due to incident light unit 380. Incident light unit 380 may be an incident light generating unit for providing incident light to display device 300.

Since TFTs 312 and/or photonic crystal units 270, 280, and/or 290 of reflective color filter 200 of display device 300 may be formed on the same substrate, reflective color filter 200 and/or TFT-array layer 310 may be manufactured in the same process. Display device 300, including photonic crystal units 270, 280, and/or 290 and/or TFTs 312 that may be formed on the same substrate, may be more easily manufactured than a general liquid crystal display including a color filter, that may be formed on an upper substrate, and a TFT-array layer, that may be formed on a lower substrate. For example, when the color filter and the TFT-array layer of the general liquid crystal display device may be bonded after being aligned in units of pixels, an alignment error may occur.

However, since reflective color filter 200 and TFT-array layer 310 of display device 300 may be disposed on the same substrate, alignment error may be reduced.

Although TFTs 312 and/or red photonic crystal units 270, green photonic crystal units 280, and/or blue photonic crystal units 290 may be formed on the same substrate in FIG. 8, example embodiments are not limited thereto. Reflective color filter 200 and TFT-array layer 310 may be formed on different layers.

While example embodiments have been particularly shown and described, it will be understood by those of ordinary skill in the art that various changes in form and details may be made therein without departing from the spirit and scope of the present invention as defined by the following claims.

What is claimed is:

1. A reflective color filter, comprising:
a transparent substrate;
a photonic crystal layer including a plurality of photonic crystal patterns; and
a light energy conversion device;
wherein the substrate is between the light energy conversion device and the photonic crystal patterns.

2. The reflective color filter of claim 1, wherein the photonic crystal layer is on the substrate.

3. The reflective color filter of claim 1, wherein the light energy conversion device contacts the substrate.

4. The reflective color filter of claim 1, wherein the light energy conversion device faces the photonic crystal patterns.

5. The reflective color filter of claim 1, further comprising:
a barrier layer between the substrate and the photonic crystal layer.

6. The reflective color filter of claim 5, wherein the barrier layer contacts the substrate.

7. The reflective color filter of claim 5, wherein the barrier layer contacts the photonic crystal layer.

8. The reflective color filter of claim 1, wherein the photonic crystal patterns have a relatively high refractive index, and
wherein the photonic crystal layer includes a low refractive index layer covering the photonic crystal patterns and having a relatively low refractive index.

9. The reflective color filter of claim 8, wherein the photonic crystal patterns include one or more of single-crystalline silicon, polycrystalline silicon (poly Si), AlSb, AlAs, AlGaAs, AlGaInP, BP, and ZnGeP₂.

10. The reflective color filter of claim 8, wherein the low refractive index layer includes one or more of air, polycarbonate (PC), polystyrene (PS), poly(methyl methacrylate) (PMMA), Si₃N₄, and SiO₂.

11. The reflective color filter of claim 1, wherein each of the photonic crystal patterns is island shaped, and
wherein the photonic crystal patterns are grouped into photonic crystal units of different sizes corresponding to red light, green light, and blue light.

12. The reflective color filter of claim 11, wherein the photonic crystal units are arranged in one or more stripe shapes, mosaic shapes, or delta shapes.

13. The reflective color filter of claim 8, further comprising:
light cut-off layers disposed on the photonic crystal patterns.

14. The reflective color filter of claim 13, wherein the light cut-off layers include silicon oxide or silicon nitride.

15. The reflective color filter of claim 1, wherein the light energy conversion device is a solar cell.

16. A reflective display device, comprising:
a liquid crystal layer having a light transmittance that is electrically controlled;
a thin film transistor (TFT)-array layer including a plurality of TFTs for driving the liquid crystal layer according to image information; and
the reflective color filter of claim 1 adapted to reflect light having a wavelength band corresponding to a photonic band gap from among light incident through the liquid crystal layer.

17. The reflective display device of claim 16, wherein the substrate is transparent.

18. The reflective display device of claim 16, further comprising:
an incident light unit disposed over the liquid crystal layer.

19. The reflective display device of claim 18, wherein the incident light unit is a light-emitting diode (LED).
